(19) United States
(12) Patent Application Publication
(10) Pub. No.: US 2024/0426698 A1
(43) Pub. Date: Dec. 26, 2024

(54) TESTING MECHANISM

(71) Applicant: Tusas- Turk Havacilik Ve Uzay Sanayii Anonim Sirketi, Ankara (TR)

(72) Inventors: Bertan ARPACIOGLU, Ankara (TR); Emre SARI, Ankara (TR)

(73) Assignee: Tusas- Turk Havacilik Ve Uzay Sanayii Anonim Sirketi, Ankara (TR)

(21) Appl. No.: 18/748,182

(22) Filed: Jun. 20, 2024

(30) Foreign Application Priority Data
Jun. 20, 2023 (TR) TR2023/007258

(51) Int. Cl. G01M 9/04

(52) U.S. Cl. CPC G01M 9/04

(57) ABSTRACT

The present invention relates to a body (2); at least one carrier (3) located on the body (2), with load carrying and/or connection functions; at least one wing (4) connected to the body (2) by means of the carrier (3) and providing the required lift to the air vehicle during a flight.

### RELATED APPLICATIONS

This application is a Paris Convention Patent Application which claims the benefit of priority of Turkey Patent Application No. TR2023/007258 filed on Jun. 20, 2023. The contents of the above application is all incorporated by reference as if fully set forth herein in its entirety.

### FIELD AND BACKGROUND OF THE INVENTION

This invention relates to a measurement and fixing mechanism used in testing processes of wings provided on air and/or space vehicles.

Wings on air vehicles are structural parts that provide sufficient lift for the air vehicle during a flight, as well as providing maneuverability to the air vehicle.

### SUMMARY OF THE INVENTION

As a component, the helicopter horizontal tail is a wing positioned at the tail of the helicopter for creating negative lift force to balance the pitching moment that occurs at the center of gravity in a forward flight, at high speeds. During forward flights of the helicopter at high speeds, different aerodynamic phenomena are observed on the right and left sides of the helicopter geometry. In addition to the dedicated aerodynamic calculations for this situation, different attack angles must be provided for the right and left wings of the helicopter in flight tests, in order to increase the balancing performance of the helicopter by the horizontal tail. In helicopter flight tests, the right and left horizontal tail wings are tested by flying at different angles of attack or by fixing the wing at different angles of attack in the wind tunnel ground testing center, so that the final horizontal tail angles of the helicopter are determined.

U.S. Pat. No. 11,273,902B2, which is included in the known-state of the art, discloses an angle of attack testing for blades or wings of an air vehicle in a wind tunnel. There is a support piece attached to the wing, and the wing is fixed to the wall via the support piece. In each angle of attack testing, the technician removes the auxiliary part from the wall, changes the angle of attack and fixes it again. Thus, any desired angle of attack can be tested. Angle of attack is determined by a measuring device.

Thanks to a testing mechanism according to the present invention, the wing is analyzed at different angles of attack using a single mechanism, so that the wing is fixed to the air vehicle.

Another object of the present invention is to carry out angle of attack tests for the wing in an economical and reliable manner.

The testing mechanism realized to achieve the object of the invention, which is defined in the first claim and other claims dependent thereon, comprises a body which is an air vehicle or is located in a wind tunnel. There is at least one carrier on the body that allows the loads attached thereon to be carried. At least one wing, which provides aerodynamic effect to the air vehicle, is connected to the body by means of the carrier.

The testing mechanism according to the invention comprises at least one main apparatus which can be removed from the carrier without causing a damage thereto. The main apparatus is attached to the carrier so as to be parallel to the body, without the capability of moving. The main apparatus extends upward and/or downward from a surface of the carrier closest to the wing. On the main apparatus, there is provided a plurality of holes (H) for fixing the wing to the carrier, and a plurality of indicators (A) for determining the angle of attack of the wing relative to the body. There is at least one auxiliary apparatus which can be removed from the wing without causing a damage thereto, and which extends upwards and/or downwards from the surface of the wing closest to the carrier. The auxiliary apparatus can move so as to remain opposite the main apparatus and to take the main apparatus as a reference. On the auxiliary apparatus, there is provided a plurality of holes (H) which are moved to be aligned with the holes (H) on the main apparatus to enable the wing to be fixed to the carrier, and a plurality of indicators (A) that enables determination of the angle of attack of the wing relative to the body. There is at least one fastener on the auxiliary apparatus, which enables that the auxiliary apparatus and the main apparatus are fixed to each other by a user at each angle of attack determined by the user, thus enabling the wing to be fixed to the body. At the angle of attack determined by the user, the user enables the holes (H) on the auxiliary apparatus to be aligned with the holes (H) and/or indicators (A) on the main apparatus and fixes the auxiliary apparatus to the main apparatus by means of the fastener, thus allowing the wing to be fixed to the body. In this way, aerodynamic testing is performed on the wing at angles of attack determined by the user. In an embodiment of the invention, the testing mechanism comprises at least one intermediate element located between the carrier and the wing. One end of the wing is inserted into the intermediate element, so that the wing can be attached to the carrier without damaging the wing. The end of the wing connected to the intermediate element is form-compatible with the intermediate element, so that intermediate elements suitable for different wing designs can be produced.

In an embodiment of the invention, the testing mechanism comprises the auxiliary apparatus which enables insertion of the fastener into the hole in each angle of attack test by enabling only the holes (H) corresponding to the angle value/indicator (A) of that angle of attack to be completely open, and which prevents insertion of the fastener into the hole (H) by at least partially closing the holes (H) for the angle values/indicators (A) of other angles of attack. Therefore, when the user wants to perform the fixing process at the angle of attack determined by the user, only the holes corresponding to that angle of attack allow screwing, thus avoiding incorrect screwing, without the need for angle measurement by the user for the fixing process.

In an embodiment of the invention, the testing mechanism comprises a center, which is the aerodynamic center provided by the air vehicle and wing by rotating their angle of attack relative to a fixed reference point. The user rotates the wing around the center and fixes the wing to the body via the fastener at each angle of attack.

In an embodiment of the invention, the testing mechanism comprises the auxiliary apparatus and main apparatus, wherein the holes (H) and indicators (A) thereon are tested individually relative to the center by the manufacturer, so as to be positioned individually for each angle of attack.

In an embodiment of the invention, the testing mechanism comprises two auxiliary apparatus extending outwards from the cover in opposite directions, perpendicular to the axis along which the cover extends; and two main apparatus extending outwards from the cover in opposite directions, perpendicular to the axis along which the surface of the carrier connected to the cover extends. The main apparatus and the auxiliary apparatus are located mirror-symmetrically.

In an embodiment of the invention, the testing mechanism comprises the auxiliary apparatus which is attached to the main apparatus via the auxiliary apparatus via four fasteners, thus allowing adequate carrying according to the weight of the wing.

In an embodiment of the invention, the testing mechanism comprises the indicator (A) that enables determination of the angle of the auxiliary apparatus relative to the main apparatus and thus the angle of the wing relative to the body.

In an embodiment of the invention, the testing mechanism comprises the auxiliary apparatus, wherein one end thereof connected to the wing is form-compatible with the wing; and the main apparatus, wherein one end thereof connected to the carrier is form-compatible with the carrier.

In an embodiment of the invention, the testing mechanism comprises the body that is an air vehicle.

In an embodiment of the invention, the testing mechanism comprises the wing, which is a horizontal tail of a rotary wing air vehicle.

### BRIEF DESCRIPTION OF THE SEVERAL VIEWS OF THE DRAWING(S)

The testing mechanism realized to achieve the object of the present invention is illustrated in the attached drawings, in which:

FIG. 1 is a perspective view of the testing mechanism.

FIG. 2 is a perspective view of the body and wings.

FIG. 3 is a schematic view of the fastener.

FIG. 4 is a schematic view of the holes (H), indicators (A) and center.

FIG. 5 is a schematic view of the holes (H) and indicators (A).

### DESCRIPTION OF SPECIFIC EMBODIMENTS OF THE INVENTION

All the parts illustrated in figures are individually assigned a reference numeral and the corresponding terms of these numbers are listed below:
1. Testing Mechanism
2. Body
3. Carrier
4. Wing
5. Intermediate Element
6. Main Apparatus
7. Auxiliary Apparatus
8. Fastener
9. Center
H. Hole
A. Indicator

The testing mechanism (1) comprises a body (2); at least one carrier (3) located on the body (2), with load carrying and/or connection functions; at least one wing (4) connected to the body (2) by means of the carrier (3) and providing the required lift to the air vehicle during a flight.

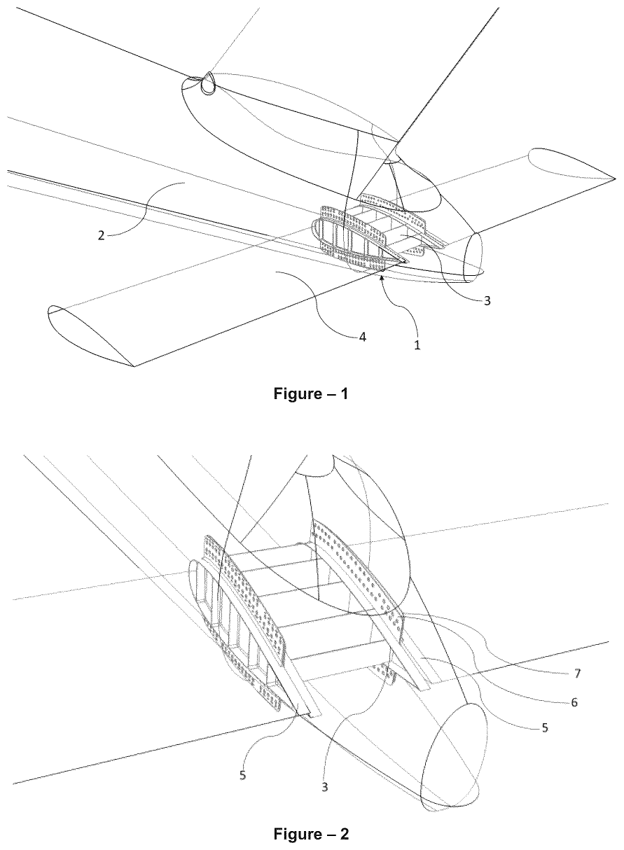

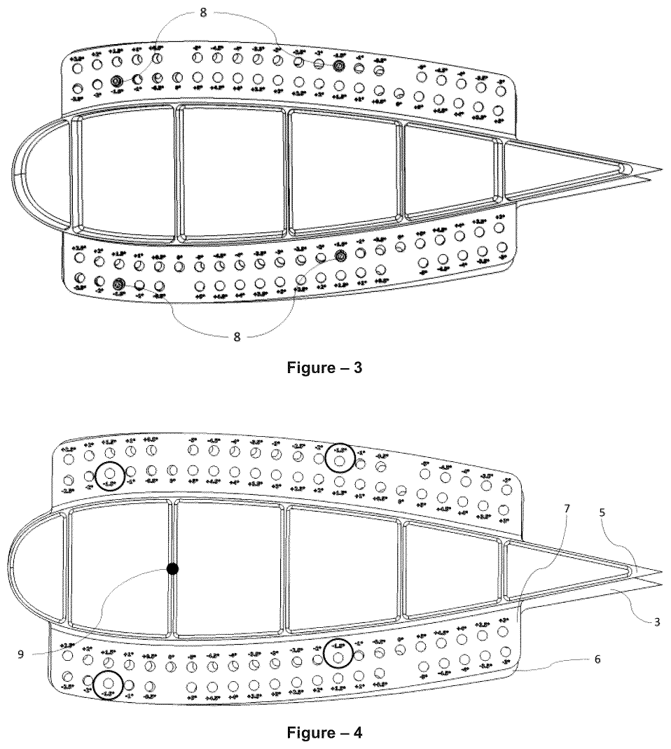

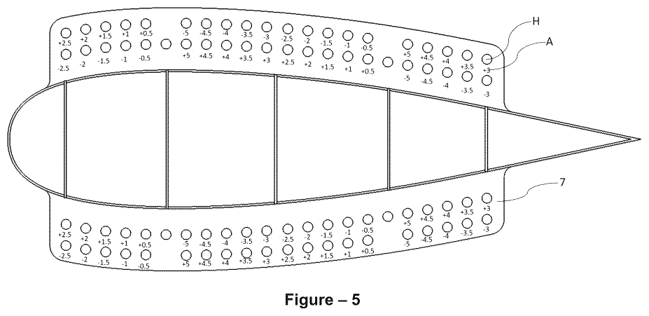

The testing mechanism (1) according to the invention comprises at least one main apparatus (6) with a plurality of holes (H) and/or a plurality of indicators (A) thereon, wherein the main apparatus (6) is removably attached to the carrier (3) and extends outward from a surface of the carrier (3) that is connected with the wing (4); at least one auxiliary apparatus (7) with a plurality of holes (H) and/or a plurality of indicators (A) thereon, wherein the auxiliary apparatus (7) is removably attached to the wing (4), extends outwards over the wing (4), and is located on the wing (4) in a movable manner; at least one fastener (8) located on the auxiliary apparatus (7) and enabling the wing (4) to be almost completely fixed to the carrier (3); wherein the auxiliary apparatus (7) is fixed to the main apparatus (6) by means of the fastener (8) when the holes (H) on the auxiliary apparatus (7) are aligned with the holes (H) and/or indicators (A) on the main apparatus (6) by the user, thus enabling the wing (4) to be tested at angles of attack determined by the user (FIG. 1, FIG. 2, FIG. 3, FIG. 5).

There is a body (2), which is an air vehicle or a wind tunnel; and a carrier (3) located on the body (2) and providing load carrying functions. The carrier (3) connects the wing (4) to the body (2) and serves as a carrier for the wing (4).

The main apparatus (6) is removably attached to the carrier (3) and extends outwards from a surface of the carrier (3) closest to the wing (4), wherein a plurality of holes (H) and a plurality of indicators (A) are provided on the main apparatus (6). The auxiliary apparatus (7) is removably attached to the wing (4), extends outwards over the wing (4), and is located on the wing (4) in a movable manner. The fastener (8) located on the auxiliary apparatus (7) enables the wing (4) to be fixed to the carrier (3), and thus to the body (2). When the auxiliary apparatus (7) is activated by the user, the holes (H) thereon are aligned with the holes (H) and/or indicators (A) on the main apparatus (6) and fixed by means of the fastener (8). Therefore, it is possible to test the wing (4) at different angles of attack.

In an embodiment of the invention, the testing mechanism (1) comprises at least one intermediate element (5) which is at least partially form-compatible with the wing (4), with one end thereof connected to the carrier (3), and the other end connected to the wing (4) so as to at least partially surround the wing (4), wherein the intermediate element (5) is rotated by the user and allows the holes (H) and/or indicators (A) on the auxiliary apparatus (7) to be aligned with the holes (H) and/or indicators (A) on the main apparatus (6), thus allowing the wing (4) to be attached to the carrier (3) by means of the fastener (8) at angles of attack determined by the user. The intermediate element (5) enables the wing (4) to be attached to the holder (3) without damaging the wing (4).

In an embodiment of the invention, the testing mechanism (1) comprises the auxiliary apparatus (7) which, in each angle of attack test, allows fixing process to be performed by means of the fastener (8) when the holes (H) thereon corresponding to the indicator (A) of that angle of attack are fully open, and which prevents the fixing process by means of the fastener (8) when the holes (H) corresponding to the indicators (A) of other angles of attack are at least partially closed, thus enabling the user to test the wing (4) at different angles of attack without using any measuring device. In this way, the user is prevented from performing a fixing process by means of an incorrect hole (H), and there is no need for the user to use an external protractor (FIG. 4).

In an embodiment of the invention, the testing mechanism (1) comprises a center (9) that forms the aerodynamic center of the wing (4); the auxiliary apparatus (7) which is rotated around the center (9) by the user and attached to the main apparatus (6) by means of the fastener (8), thus allowing flight tests to be carried out at angles of attack predetermined by the user. The center (9) is predetermined by the manufacturer.

In an embodiment of the invention, the testing mechanism (1) comprises the auxiliary apparatus (7) created by indicators (A) and holes (H) at positions predetermined by the manufacturer relative to the center (9). Therefore, the user can easily perform the fixing process and achieve the desired attack angles without the need for measurements.

In an embodiment of the invention, the testing mechanism (1) comprises two auxiliary apparatus (7), preferably mirror symmetrical with respect to the cover (4); and two main apparatus (6) which are mirror symmetrical with respect to the carrier (3). Thanks to their mirror symmetrical nature, fixing process can be performed at the bottom and top of the center (9).

In an embodiment of the invention, the testing mechanism (1) comprises the auxiliary apparatus (7) which is attached to the main apparatus (6) preferably by means of four fasteners (8), thus enabling the wing to be completely fixed to the carrier (3) while the wing (4) is being tested. Therefore, the wing (4) is prevented from vibrating at an undesirable level during the flight test.

In an embodiment of the invention, the testing mechanism (1) comprises the indicator (A) configured to indicate the inclination of the auxiliary apparatus (7) relative to the main apparatus (6).

In an embodiment of the invention, the testing mechanism (1) comprises the auxiliary apparatus (7) which is geometrically form-compatible with the wing (4). Therefore, even in cases where the design of the wing (4) is distinct, measurement and fixing processes are enabled by means of the auxiliary apparatus (7).

In an embodiment of the invention, the testing mechanism (1) comprises the body (2) which is an air vehicle.

In an embodiment of the invention, the testing mechanism (1) comprises the wing (4) which is a helicopter horizontal tail.

1. A testing mechanism comprising a body; at least one carrier located on the body, with load carrying and/or connection functions; at least one wing connected to the body by means of the carrier and providing the required lift to the air vehicle during a flight, wherein at least one main apparatus with a plurality of holes (H) and/or a plurality of indicators (A) thereon, wherein the main apparatus is removably attached to the carrier and extends outward from a surface of the carrier that is connected with the wing; at least one auxiliary apparatus with a plurality of holes (H) and/or a plurality of indicators (A) thereon, wherein the auxiliary apparatus is removably attached to the wing, extends outwards over the wing, and is located on the wing in a movable manner; at least one fastener located on the auxiliary apparatus and enabling the wing to be almost completely fixed to the carrier; wherein the auxiliary apparatus is fixed to the main apparatus by means of the fastener when the holes (H) on the auxiliary apparatus are aligned with the holes (H) and/or indicators (A) on the main apparatus by the user, thus enabling the wing to be tested at angles of attack determined by the user.

2. A testing mechanism according to claim 1, wherein at least one intermediate element which is at least partially form-compatible with the wing, with one end thereof connected to the carrier, and the other end connected to the wing so as to at least partially surround the wing, wherein the intermediate element is rotated by the user and allows the holes (H) and/or indicators (A) on the auxiliary apparatus to be aligned with the holes (H) and/or indicators (A) on the main apparatus, thus allowing the wing to be attached to the carrier by means of the fastener at angles of attack determined by the user.

3. A testing mechanism according to claim 1, wherein the auxiliary apparatus which, in each angle of attack test, allows fixing process to be performed by means of the fastener when the holes (H) thereon corresponding to the indicator (A) of that angle of attack are fully open, and which prevents the fixing process by means of the fastener when the holes (H) corresponding to the indicators (A) of other angles of attack are at least partially closed, thus enabling the user to test the wing at different angles of attack without using any measuring device.

4. A testing mechanism according to claim 1, wherein a center that forms the aerodynamic center of the wing; the auxiliary apparatus which is rotated around the center by the user and attached to the main apparatus by means of the fastener, thus allowing flight tests to be carried out at angles of attack predetermined by the user.

5. A testing mechanism according to claim 4, wherein the auxiliary apparatus created by indicators (A) and holes (H) at positions predetermined by the manufacturer relative to the center.

6. A testing mechanism according to claim 1, wherein two auxiliary apparatus, preferably mirror symmetrical with respect to the cover; and two main apparatus which are mirror symmetrical with respect to the carrier.

7. A testing mechanism according to claim 1, wherein the auxiliary apparatus which is attached to the main apparatus preferably by means of four fasteners, thus enabling the wing to be completely fixed to the carrier while the wing is being tested.

8. A testing mechanism according to claim 1, wherein the indicator (A) configured to indicate the inclination of the auxiliary apparatus relative to the main apparatus.

9. A testing mechanism according to claim 1, wherein the auxiliary apparatus which is geometrically form-compatible with the wing.

10. A testing mechanism according to claim 1, wherein the body which is an air vehicle.

11. A testing mechanism according to claim 1, wherein the wing which is a helicopter horizontal tail.
